(19) United States
(12) Patent Application Publication
(10) Pub. No.: US 2021/0046766 A1
(43) Pub. Date: Feb. 18, 2021

(54) THERMAL PRINTER

(71) Applicants: CITIZEN WATCH CO., LTD., Tokyo (JP); CITIZEN SYSTEMS JAPAN CO., LTD., Tokyo (JP)

(72) Inventors: Yasuyuki MORI, Tokyo (JP); Hiroshi SAKURAI, Saitama (JP); Masakazu MATSUI, Tokyo (JP); Takuro KOHYAMA, Tokyo (JP)

(21) Appl. No.: 16/976,452

(22) PCT Filed: Mar. 2, 2019
(86) PCT No.: PCT/JP2019/008224

§ 371 Date: Aug. 27, 2020

(30) Foreign Application Priority Data
Mar. 2, 2018 (JP) 2018-038035

(51) Int. Cl. B41J 2/325; B41J 11/04; B41J 11/42

(52) U.S. Cl. CPC B41J 2/325; B41J 11/42; B41J 11/04

(57) ABSTRACT

A thermal printer is provided which starts up at a practical speed and whose ink ribbon is unlikely to leave trails on a recording medium. The thermal printer includes a first transporting unit transporting an ink ribbon, a second transporting unit transporting a recording medium, at least one motor driving the first transporting unit and the second transporting unit simultaneously, a thermal head thermally transferring ink of the ink ribbon onto the recording medium to print, and a controller accelerating the motor from a rest state to a target speed while the recording medium and the ink ribbon are pressed against the thermal head. The controller accelerates the motor in a first period which is a mechanical delay time required for driving force of the motor in the rest state to be transmitted to the second transporting unit, drives the motor at a constant speed or accelerates the motor at a rate smaller than that of the first period in a second period from when the first period is ended and before the target speed is reached, and accelerates the motor at a rate greater than that of the second period in a third period from when the second period is ended until the target speed is reached.

### FIELD

The present invention relates to a thermal printer.

### BACKGROUND

Patent Literature 1 discloses that in a thermal transfer printer transporting paper and printing thereon with a print head through an ink ribbon, the ink ribbon, which is transported by a direct-current motor, lags behind the paper, which is transported by a stepping motor, at the start of printing because the types of the motors differ. Patent Literature 1 also discloses that since this lagging causes ink stains on the paper and creases and breakages of the ink ribbon, at the start of printing, driving of the direct-current motor for transporting the ink ribbon is started a predetermined time before driving of the stepping motor for transporting the paper is started.

### CITATION LIST

### Patent Literature

Patent Literature 1: Japanese Unexamined Patent Publication No. 2007-118536

### SUMMARY

In a thermal printer (thermal transfer printer) using an ink ribbon, even if it includes a single motor whose rotation is transmitted to the ink ribbon and a recording medium through a bifurcated route including gears, when the ink ribbon and the recording medium start moving at the start of printing, they may be rubbed together and thereby trails of the ink ribbon (smudges) may be left on the recording medium. The reason for this is supposed that backlash of gears in the printer for transporting the ink ribbon and the recording medium or slack of the ink ribbon delays winding of the ink ribbon, and thus the recording medium starts moving slightly earlier than the ink ribbon. Since such ribbon trails are stains and decreases the quality of printed sheets, it is necessary to prevent the ribbon trails from being left. If the startup of the motor is slowed down, the difference between the speeds of the ink ribbon and the recording medium in the period up to when the motor reaches a target speed decreases and such ribbon trails are unlikely to be left; however, simply slowing the motor speed is not desirable because the print speed decreases.

In the invention of Patent Literature 1, in order to prevent ink stains on the paper and creases and breakages of the ink ribbon which are caused by the ink ribbon lagging behind the paper at the start of printing, one of the two motors whose acceleration curves differ is started earlier than the other so that the motors are started in a period during which their acceleration curves coincide. However, since individual motors have different startup characteristics, even if the motor for the ink ribbon is driven earlier than the motor for the recording medium, the startup characteristics of the two motors may not necessarily coincide in a desired period. Moreover, since the motors are not the only cause of lagging of the ink ribbon as described above, the difference between the speeds of the ink ribbon and the recording medium may not sufficiently decrease and there is still a possibility that the ribbon trails will be left.

It is an object of the present invention to provide a thermal printer which starts up at a practical speed and whose ink ribbon is unlikely to leave trails on a recording medium.

Provided is a thermal printer including a first transporting unit transporting an ink ribbon, a second transporting unit transporting a recording medium, at least one motor driving the first transporting unit and the second transporting unit simultaneously, a thermal head thermally transferring ink of the ink ribbon onto the recording medium to print, and a controller accelerating the motor from a rest state to a target speed while the recording medium and the ink ribbon are pressed against the thermal head. As acceleration control, the controller accelerates the motor in a first period which is a mechanical delay time required for driving force of the motor in the rest state to be transmitted to the second transporting unit, drives the motor at a constant speed or accelerates the motor at a rate smaller than that of the first period in a second period from when the first period is ended and before the target speed is reached, and accelerates the motor at a rate greater than that of the second period in a third period from when the second period is ended until the target speed is reached.

In the first period, the controller preferably accelerates the motor at a rate greater than that of the third period.

The at least one motor is preferably a single motor.

Preferably, the thermal printer is capable of printing in a high-speed mode or a low-speed mode, the target speed and a print speed being smaller in the low-speed mode than in the high-speed mode, and the controller performs the acceleration control in the high-speed mode and does not perform the acceleration control in the low-speed mode.

Preferably, the thermal printer is capable of printing in a thermal transfer mode in which the ink ribbon is used or in a thermosensitive mode in which a thermal recording medium is used as the recording medium without the ink ribbon, the thermal printer further comprises a memory storing thermal-transfer control data for the acceleration control and thermosensitive control data for second acceleration control in which the motor is accelerated from the rest state to the target speed in a shorter time than in the acceleration control, the thermal head heats the recording medium to print in the thermosensitive mode, and the controller performs the acceleration control or the second acceleration control.

Preferably, in the second acceleration control, the controller accelerates the motor at a rate greater than that of the second period of the acceleration control in at least a period corresponding to the second period.

Preferably, the thermal printer further includes an input unit through which a user is able to select which is to be performed, the acceleration control or the second acceleration control, wherein the controller performs the acceleration control or the second acceleration control to accelerate the motor in accordance with an input to the input unit.

The above thermal printer starts up at a practical speed and its ink ribbon is unlikely to leave trails on a recording medium.

### BRIEF DESCRIPTION OF DRAWINGS

FIG. 1 is a perspective view showing the outward appearance of a printer 1.

FIG. 2 is a perspective view of the printer 1 with a cover 20 being open.

FIG. 3 is a perspective view of the printer 1 with a top cover 30 being open.

FIG. 4 is a perspective view showing part of a printing unit 40.

FIG. 5 is a left side view of the printing unit 40.

FIG. 6 is a schematic diagram showing the disposition of an ink ribbon 2 in the printing unit 40.

FIGS. 7(A) to 7(D) are diagrams for explaining an anti-deforming structure of the cover 20.

FIG. 8 is a perspective view of the printing unit 40 seen from the bottom side thereof.

FIGS. 9(A) and 9(B) are schematic block diagrams of the printer 1.

FIG. 10 is a graph for explaining acceleration control of a motor 12 of the printer 1.

### DESCRIPTION OF EMBODIMENTS

Hereinafter, a thermal printer will be described with reference to the accompanying drawings. However, note that the present invention is not limited to the drawings or the embodiments described below.

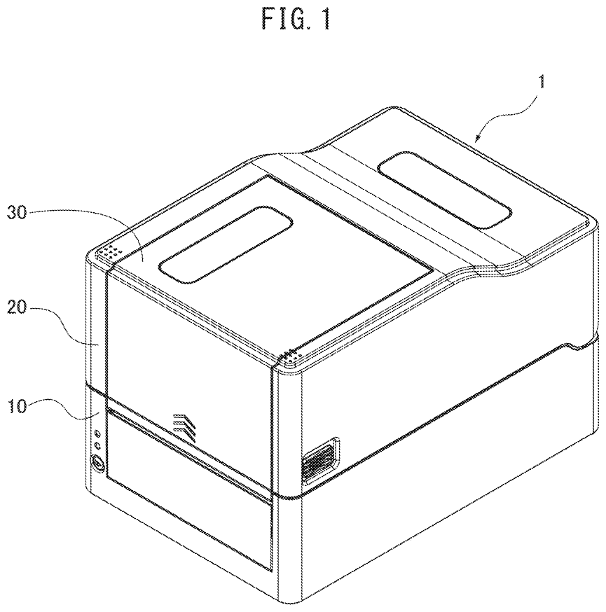

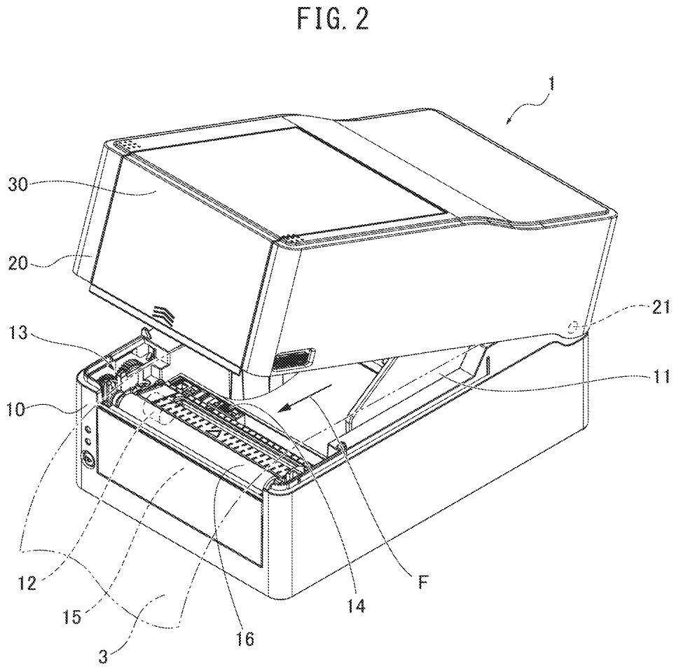

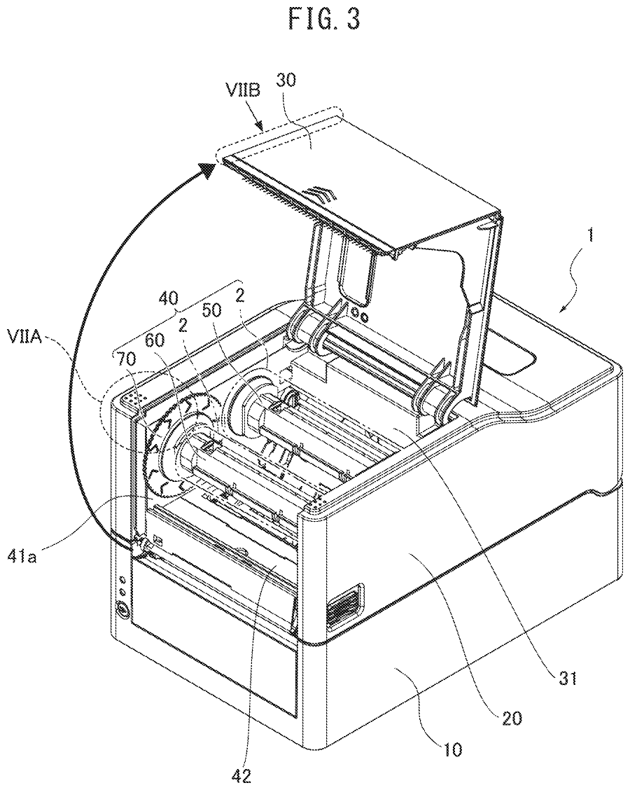

FIG. 1 is a perspective view showing the outward appearance of a printer 1. The printer 1 includes a body 10 and a cover 20. The cover 20 is provided with a top cover 30 covering the front and top surfaces thereof. The cover 20 and the top cover 30 shown in FIG. 1 are closed. FIG. 2 is a perspective view of the printer 1 with the cover 20 being open. FIG. 3 is a perspective view of the printer 1 with the top cover 30 being open.

The printer 1 is a thermal printer (thermal transfer printer) thermally transferring ink of an ink ribbon 2 onto paper 3 to print images or letters. The paper 3, which is an example of the recording medium, is belt-like continuous paper wound into a roll. The paper 3 may be, for example, label paper composed of backing paper and peelable labels affixed thereto; in this case, the printer 1 is also referred to as a label printer. The paper 3 may be made of any material, such as a cloth or a ribbon, without limitation. FIG. 2 shows the paper 3 as being transparent in order to show the internal structure of the printer 1.

The cover 20 is rotatably fixed at its lower rear edge indicated by reference numeral 21 to the upper rear edge of the body 10. Thus, as shown in FIG. 2, the cover 20 is rotatable toward the upper rear side of the body 10 around the supported portion indicated by reference numeral 21.

The body 10 has a paper space 11 for housing the paper 3 therein. Unlike the illustrated example, the body 10 may not have the paper space 11, and a user may set the paper 3 outside the body 10. In addition to the paper space 11, the body 10 includes a motor 12, a gear train 13, a paper sensor 14, a control unit 15 and a platen roller 16.

The motor 12 is a stepper motor for transporting the ink ribbon 2 and the paper 3, and is driven to rotate the gear train 13 under the control of the control unit 15. The gear train 13 is placed inside the body 10 on the left side surface thereof as seen from the front of the printer 1. The gear train 13 is a recording-medium transferring mechanism for transmitting the driving force of the motor 12 to the paper 3, and is driven by the motor 12 to rotate the platen roller 16. The paper sensor 14 detects marks (not shown), such as black marks, notches or through-holes, provided on the paper 3.

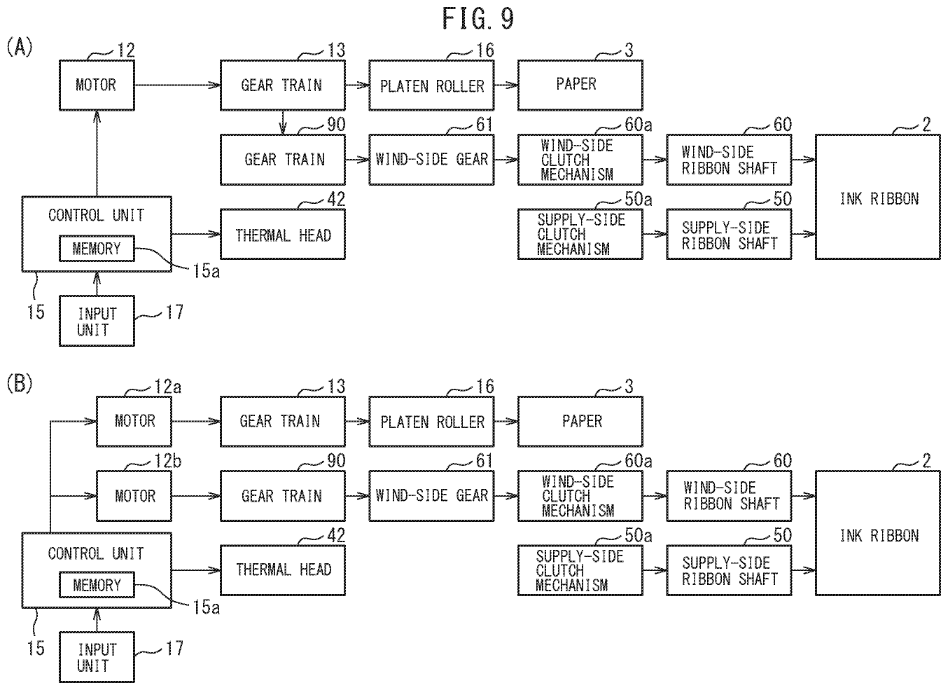

The control unit 15 is constructed from a microcomputer on a substrate in the body 10, and includes a CPU and a memory (memory 15a in FIG. 9(A) described below). The control unit 15, which is an example of the controller, drives the motor 12 to control transport of the ink ribbon 2 and the paper 3 in accordance with detection results of the paper sensor 14, and drives a thermal head 42 (see FIG. 3) in the cover 20 to perform printing. The platen roller 16, which is an example of the second transporting unit, is driven to rotate by the motor 12 through the gear train 13 with the paper 3 sandwiched between the platen roller 16 and the thermal head 42, thereby transporting the paper 3 in the direction of arrow F toward the front side of the printer 1.

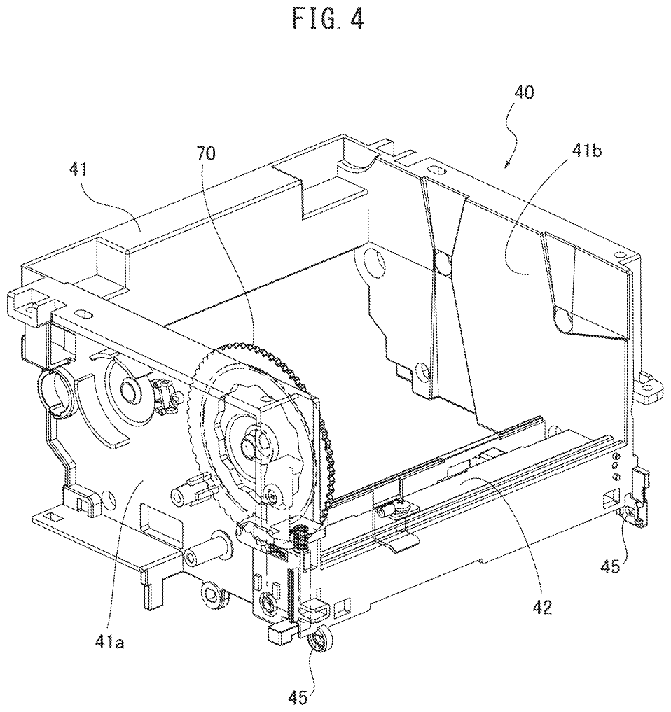

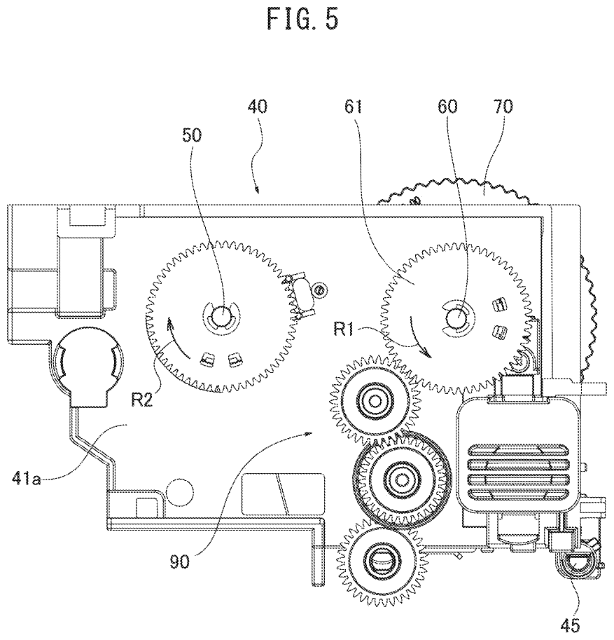

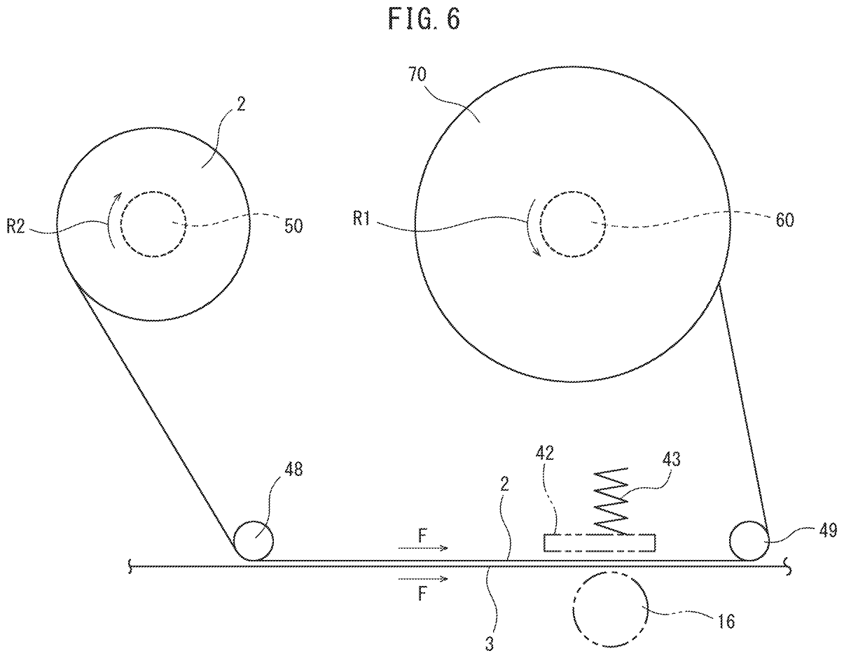

As shown in FIG. 3, the cover 20 has an ink-ribbon space 31 for housing the ink ribbon 2 therein, and in the ink-ribbon space 31, a printing unit 40 is housed. FIG. 4 is a perspective view showing part of the printing unit 40. FIG. 5 is a left side view of the printing unit 40. FIG. 6 is a schematic diagram showing the disposition of the ink ribbon 2 in the printing unit 40. The printing unit 40 includes a support member 41, a thermal head 42, a spring 43, a ribbon guide 48, a guide shaft 49, a supply-side ribbon shaft 50, a wind-side ribbon shaft 60, a wind-side gear 61, a ribbon flange 70 and a gear train 90.

The support member 41 is a box-shaped member supporting the thermal head 42, the supply-side ribbon shaft 50 and the wind-side ribbon shaft 60, and includes side walls 41a and 41b on the respective ends in the width direction. FIG. 5 shows the side wall 41a of the support member 41 on the left side as seen from the front of the printer 1. The width direction of the support member 41 is the same as that of the cover 20.

As shown in FIG. 6, when the cover 20 is closed, the thermal head 42 is disposed immediately above the platen roller 16, and is pressed against the platen roller 16 by the spring 43 with the ink ribbon 2 and the paper 3 sandwiched between the thermal head 42 and the platen roller 16. The thermal head 42, which is an example of the printing unit, heats internal heating elements in accordance with image data to be printed (print data) under the control of the control unit 15, and thereby thermally transfers the ink of the ink ribbon 2 onto the paper 3 to print images and letters on the paper 3.

The ribbon guide 48 and the guide shaft 49 are members guiding the ink ribbon 2 in the printing unit 40. In the transport path of the ink ribbon 2, the ribbon guide 48 is disposed between the supply-side ribbon shaft 50 and the thermal head 42 while the guide shaft 49 is disposed between the thermal head 42 and the wind-side ribbon shaft 60.

The supply-side ribbon shaft 50 is a shaft on which an unused portion of the ink ribbon 2 is wound into a roll while the wind-side ribbon shaft 60 is a shaft on which a used portion of the ink ribbon 2 is wound into a roll. The wind-side ribbon shaft 60, which is an example of the first transporting unit, winds the ink ribbon 2 with the driving force of the motor 12 to transport the ink ribbon 2. The supply-side ribbon shaft 50 and the wind-side ribbon shaft 60 are hung between the side walls 41a and 41b of the support member 41. The ribbon flange 70 is a disk-shaped member provided on the wind-side ribbon shaft 60 more inward than the side wall 41a of the support member 41, and prevents the ink ribbon 2 wound on the wind-side ribbon shaft 60 from leaning to one side of the wind-side ribbon shaft 60.

As shown in FIG. 6, when being used, the ink ribbon 2 is drawn out from the supply-side ribbon shaft 50, transported in the direction of arrow F, and wound on the wind-side ribbon shaft 60 via the ribbon guide 48, the thermal head 42 and the guide shaft 49. At this time, the platen roller 16 rotates while the thermal head 42 is press against the platen roller 16 with the ink ribbon 2 and the paper 3 sandwiched therebetween, and thereby the paper 3 is also transported in the direction of arrow F together with the ink ribbon 2.

As shown in FIG. 5, the wind-side gear 61 is coupled to an end of the wind-side ribbon shaft 60 piercing through the side wall 41a, and rotates together with the wind-side ribbon shaft 60. The gear train 90 is disposed on the outer surface of the side wall 41a, engages with the wind-side gear 61, and also engages with the gear train 13 of the body 10 when the cover 20 is closed. Accordingly, the wind-side ribbon shaft 60 is separated from the motor 12 when the cover 20 is open, but it is coupled to the motor 12 via the gear trains 13 and 90 and the wind-side gear 61 when the cover 20 is closed. The gear train 90 is an ink-ribbon transferring mechanism for transmitting the driving force of the motor 12 to the ink ribbon 2, and is driven by the motor 12 to rotate the wind-side ribbon shaft 60 in the direction of arrow R1 (anticlockwise in FIG. 5) when the cover 20 is closed. This causes the ink ribbon 2 to be wound on the wind-side ribbon shaft 60.

When the cover 20 is closed and the motor 12 is stopped, the wind-side ribbon shaft 60 remains at rest by braking force generated by the motor 12 being stopped. When the cover 20 is open, the braking force of the motor 12 does not act on the wind-side ribbon shaft 60, but rotation of the wind-side ribbon shaft 60 is restricted by a mechanism (not shown) including the ribbon flange 70.

The supply-side ribbon shaft 50 and the wind-side ribbon shaft 60 are provided with clutch mechanisms (a supply-side clutch mechanism 50a and a wind-side clutch mechanism 60a in FIG. 9(A) described below) each including a torsion spring. The torsion spring of the supply-side ribbon shaft 50 applies torque in the direction of arrow R2 (clockwise in FIG. 5), which is opposite to the direction of arrow R1 in which the ink ribbon 2 is wound, and that of the wind-side ribbon shaft 60 applies torque in the direction of arrow R1. Since this torque stretches the ink ribbon 2 between the supply-side ribbon shaft 50 and the wind-side ribbon shaft 60 toward both shafts, the ink ribbon 2 always receives tensile force and is thus stretched without slackening.

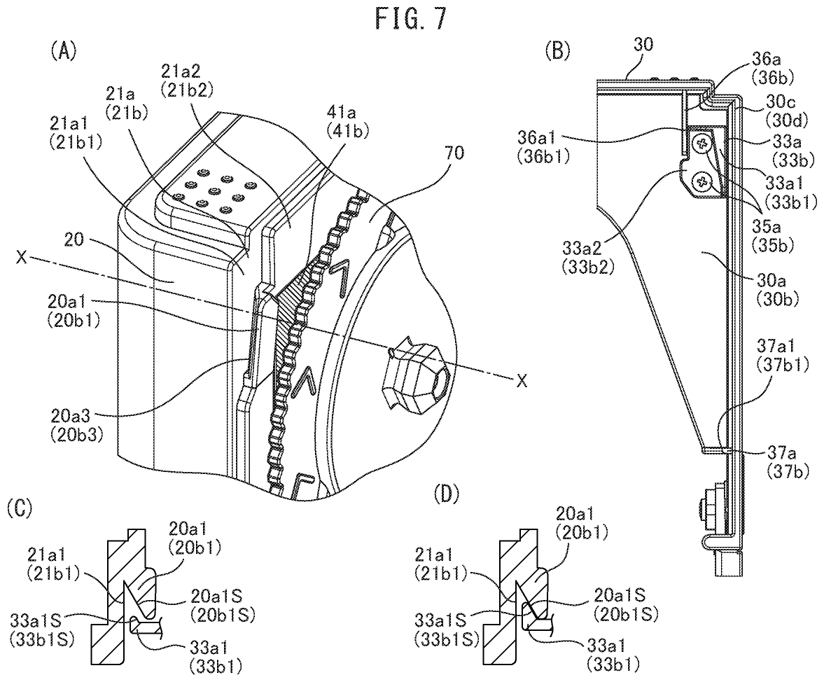

FIGS. 7(A) to 7(D) are diagrams for explaining an anti-deforming structure of the cover 20. FIG. 7(A) is a perspective view showing part of the cover 20 indicated by reference numeral VIIA in FIG. 3, and FIG. 7(B) is a side view showing part of the top cover 30 seen from the side of reference numeral VIIB in FIG. 3 in enlarged form. The right side of FIG. 7(B) corresponds to the front of the top cover 30 (the printer 1). FIGS. 7(C) is a cross-sectional view showing the principal part of the anti-deforming structure with the top cover 30 being half closed, and FIGS. 7(D) is a cross-sectional view showing the same part with the top cover 30 being closed. These figures show cross sections which are cut along the horizontal plane at the height of X-X line in FIG. 7(A) and seen from the upper side thereof. Since the side surfaces of the cover 20 are placed on both sides of the top cover 30 on the front side of the printer 1 so as to sandwich the top cover 30 in the width direction of the printer 1, the cover 20 is likely to deform in the width direction so as to separate from the top cover 30 under stress produced inside the printer 1 or under prolonged high-temperature conditions. In order to prevent this deformation, the cover 20 and the top cover 30 are provided with the following anti-deforming structure.

As shown in FIG. 7(A), the cover 20 includes a wall 21a on an inner surface thereof (inner surface on the width side of the printer 1) so as to cover the side wall 41a of the support member 41 indicated by a hatch pattern and its surroundings. The wall 21a is composed of an outer wall 21a1 and an inner wall 21a2 which is raised on the outer wall 21a1 inward in the width direction of the cover 20. Although illustration is omitted, the cover 20 also includes a wall 21b which has a similar structure on the side opposite to the wall 21a. In FIGS. 7(A) to 7(D), reference numerals of corresponding components on the wall 21b side are shown in parentheses. In the following description also, reference numerals of components on the wall 21b side corresponding to those illustrated in the figures are shown in parentheses, and explanation thereof is omitted herein. In FIG. 7(A), a flat portion at the top of the side wall 41a of the support member 41 shown in FIG. 4 is housed in the cover 20 and is not visible. The same holds true for a flat portion at the top of the side wall 41b of the support member 41.

The wall 21a (21b) of the cover 20 includes an engaging portion 20a1 (20b1) to be engaged with the top cover 30, near the upper edge thereof. The engaging portion 20a1 (20b1) is formed so as to be separate from the outer wall 21a1 (21b1) of the cover 20 with a gap 20a3 (20b3) interposed therebetween.

As shown in FIG. 7(B), each side portion of the top cover 30 includes an engaging member 33a (33b) attached at a position facing the engaging portion 20a1 (20b1) of the cover 20, and a wall 30a (30b) placed inward in the width direction of the printer 1 with respect to an edge 30c (30d) of the top cover 30. The engaging member 33a (33b) includes a fixing portion 33a2 (33b2) having screw holes, and an engaging portion 33a1 (33b1) separated from the fixing portion 33a2 (33b2) outward in the width direction of the printer 1. The engaging member 33a (33b) is formed separately from the top cover 30, and is fixed to the wall 30a (30b) with screws 35a (35b) through the fixing portion 33a2 (33b2). The engaging portion 33a1 (33b1) has a planar shape of a right-angled triangle, and as seen from the lateral side of the top cover 30, the screws 35a (35b) are exposed without being covered by the engaging portion 33a1 (33b1).

As shown in FIGS. 7(C) and 7(D), the engaging portion 20a1 (20b1) of the cover 20 and the engaging portion 33a1 (33b1) of the top cover 30 each have a tapered shape whose tip is chamfered, and respectively have an inclined surface 20a1S (20b1S) and an inclined surface 33a1S (33b1S) facing each other. FIG. 7(C) shows a state in which the top cover 30 is half closed, and the engaging portion 33a1 (33b1) shown in this figure is a cross section of a narrow part on the lower side in FIG. 7(B). In the state of FIG. 7(C), the tips of the engaging portions are separate in the width direction of the printer 1; thus, even if the cover 20 or the top cover 30 is slightly shifted in the width direction of the printer 1, the engaging portion 33a1 (33b1) is reliably inserted between the engaging portion 20a1 (20b1) and the outer wall 21a1 (21b1).

In the state of FIG. 7(D) in which the top cover 30 is closed, the engaging portion 33a1 (33b1) of the top cover 30 is inserted between the engaging portion 20a1 (20b1) and the outer wall 21a1 (21b1) of the cover 20, and the inclined surfaces 33a1S (33b1S) and 20a1S (20b1S) are in contact with each other and overlap in the width direction of the printer 1. The engaging portion 33a1 (33b1) of the top cover 30 is thereby engaged with the engaging portion 20a1 (20b1) of the cover 20. In this state, even if force acts on a portion of the cover 20 near the engaging portion 20a1 (20b1) so as to widen the cover 20 in the width direction, the engagement between the engaging portions 33a1 (33b1) and 20a1 (20b1) prevents the cover 20 from deforming in this direction.

Each side portion of the top cover 30 further includes a rib 36a (36b) and a rib 37a (37b). The ribs 36a (36b) and 37a (37b) are formed so that their end faces on the width side of the printer 1 may come into contact with the inner wall 21a2 (21b2) of the cover 20. This structure prevents the situation that the cover 20 is deformed in the width direction of the printer 1 toward the top cover 30 so that the top cover 30 cannot be closed.

The rib 36a (36b) is formed so that the portion thereof placed above a boundary 36a1 (36b1) shown in FIG. 7(B) may come into contact with the inner wall 21a2 (21b2) of the cover 20 and that the portion thereof placed below the boundary 36a1 (36b1) may be separate from the inner wall 21a2 (21b2). The portion of the rib 36a (36b) placed below the boundary 36a1 (36b1) is formed as follows: its bottom in FIG. 7(B) is substantially the same height as the fixing portion 33a2 (33b2); the boundary 36a1 (36b1) has a height such that it may come into contact with the inner wall 21a2 (21b2); and the portion therebetween slopes (the height in the width direction of the printer 1 increases). Similarly, the rib 37a (37b) is formed so that the height of the portion thereof on the left of a boundary 37a1 (37b1) in FIG. 7(B) gradually increases from the left end toward the boundary 37a1 (37b1) and that the portion thereof on the right of the boundary 37a1 (37b1) may come into contact with the inner wall 21a2 (21b2). Accordingly, at the time of closing the top cover 30, the portion of the rib 36a (36b) placed below the boundary 36a1 (36b1) and the portion of the rib 37a (37b) on the left of the boundary 37a1 (37b1) do not come into contact with the inner wall 21a2 (21b2) of the cover 20, which allows the top cover 30 to be smoothly closed.

As described above, the anti-deforming structure shown in FIGS. 7(A) to 7(D) includes a cover (the top cover 30) which is openable and closable by being rotated around a predetermined axis, and a housing (the cover 20) which has walls (the walls 21a and 21b) respectively facing side portions of the closed cover in the direction of the axis of the cover (the width direction of the printer 1). This anti-deforming structure includes a first engaging portion (the engaging portion 20a1 or 20b1) on one of the walls, and a second engaging portion (the engaging portion 33a1 or 33b1) on one of the side portions of the cover facing the one of the walls, the first and second engaging portions engaging in the direction of the axis. This structure can prevent portions of the housing including the walls from being separated from the cover in the direction of the axis. This anti-deforming structure further includes a contact portion (the rib 36a, 36b, 37a or 37b) on the one of the side portions of the cover, the contact portion being configured to come into contact with the one of the walls. This structure can prevent the situation that the portions of the housing including the walls are deformed in the direction of the axis toward the cover so that the cover cannot be closed.

The printer including the above anti-deforming structure includes a cover (the top cover 30) which is openable and closable by being rotated around a predetermined axis, and a housing (the cover 20) which has walls (the walls 21a and 21b) respectively facing side portions of the closed cover in the direction of the axis of the cover (the width direction of the printer 1), wherein a first engaging portion (the engaging portion 20a1 or 20b1) is provided on one of the walls, and a second engaging portion (the engaging portion 33a1 or 33b1) is provided on one of the side portions of the cover facing the one of the walls, and the first and second engaging portions engage in the direction of the axis. The axis is, for example, an edge of the cover, and the cover is rotatable therearound.

The above printer may include a contact portion on the one of the side portions of the cover, the contact portion being configured to come into contact with the one of the walls. The engaging members 33a and 33b of the above printer are components separate from the top cover 30, but may be integrated with the top cover 30.

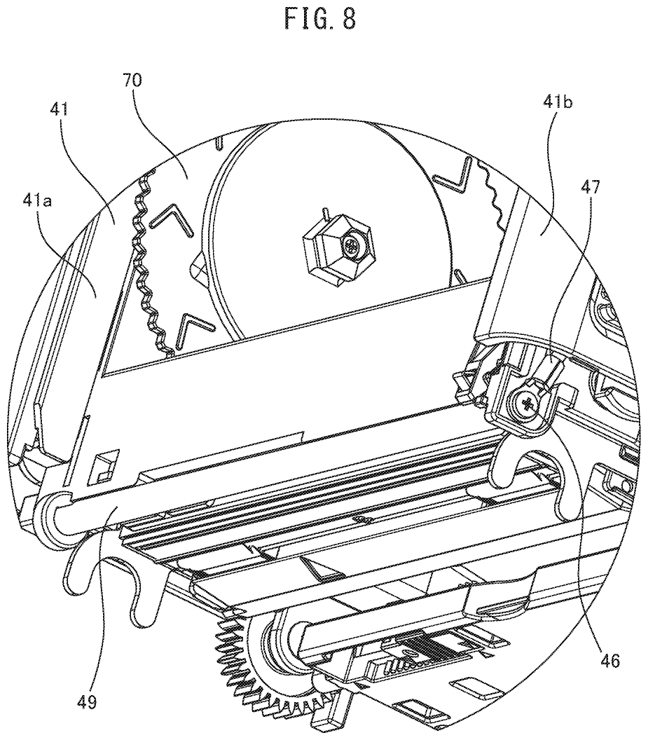

FIG. 8 is a perspective view of the printing unit 40 seen from the bottom side thereof. The support member 41 and the guide shaft 49 are made of resin and metal, respectively, and as shown in FIG. 4, the side walls 41a and 41b of the support member 41 have a pair of holes 45 for fixing the guide shaft 49 at their bottoms on the front side of the printer 1. The ends of the guide shaft 49 are inserted into the holes 45 and fixed.

Since the ink ribbon 2 is transported so as to be rubbed against the guide shaft 49, static electricity is likely to be generated on the guide shaft 49. In order to discharge the static electricity generated on the guide shaft 49, a screw 46 is inserted into a screw hole (not shown) at the edge of the guide shaft 49 on the side wall 41b side, and a connecting line 47 is attached with the screw 46. The connecting line 47 is connected to a ground pattern on a circuit board (not shown) included in the body 10. This structure allows for discharging the static electricity generated on the guide shaft 49 into the ground pattern on the circuit board, and thereby preventing a trouble resulting from the static electricity.

If the support member 41 is produced from a sheet metal, it will be expensive although the static electricity generated on the guide shaft 49 attached to the support member 41 can be discharged by connecting the support member 41 to the ground pattern. If the support member 41 and a portion corresponding to the guide shaft 49 are integrated through resin molding, the static electricity generated on the guide shaft 49 cannot be discharged into the ground pattern although the manufacturing cost will be low. In the present embodiment, in contrast to the above cases, the support member 41 and the guide shaft 49 are made of resin and metal, respectively, and the guide shaft 49 is electrically connected to the ground pattern, which allows for preventing a trouble resulting from the static electricity with an inexpensive structure.

FIGS. 9(A) and 9(B) are schematic block diagrams of the printer 1. The arrows in FIG. 9(A) indicate that the driving force of the motor 12 is transmitted to the paper 3 through the gear train 13 and the platen roller 16 of the body 10 and transmitted to the ink ribbon 2 through the gear train 13, and the gear train 90, the wind-side gear 61, the wind-side clutch mechanism 60a and the wind-side ribbon shaft 60 of the cover 20 in this order, as described above. The supply-side clutch mechanism 50a applies tensile force to the ink ribbon 2 through the supply-side ribbon shaft 50, but is not coupled to the motor 12; thus, in FIG. 9(A), the arrow from the motor 12 is not connected to the supply-side clutch mechanism 50a.

The input unit 17 in FIG. 9(A) corresponds to, for example, an operation button provided on the body 10 or an external input terminal to be connected to an external device, such as a host computer. The arrows in FIG. 9(A) indicate that the control unit 15 drives the motor 12 and the thermal head 42 in accordance with a print instruction inputted to the printer 1 through the input unit 17.

Although the motor 12 of the printer 1 serves as a transport motor for the ink ribbon 2 and the paper 3, they may be transported by separate motors. In other words, the number of motors transporting the ink ribbon 2 and the paper 3 is not limited to one and may be two or more. FIG. 9(B) shows an example in which the paper 3 is transported by a motor 12a and the ink ribbon 2 is transported by a motor 12b which differs from the motor 12a. In this case, the motors 12a and 12b are driven by the control unit 15 in a synchronized manner (simultaneously) because the ink ribbon 2 and the paper 3 are simultaneously transported during printing. In this way, the first transporting unit transporting the ink ribbon 2 and the second transporting unit transporting a recording medium, such as the paper 3, can be driven by the motor 12, which is the at least one motor, or the motors 12a and 12b.

As described above, in a thermal printer using an ink ribbon, when the ink ribbon and the recording medium start moving by driving a motor at the start of printing, winding of the ink ribbon is delayed and thereby trails of the ink ribbon may be left on the recording medium. These ribbon trails may be left not only in the case of FIG. 9(A) in which the ink ribbon 2 and the paper 3 are transported by the single motor 12, but also in the case of FIG. 9(B) in which the ink ribbon 2 and the paper 3 are transported by the separate motors 12a and 12b, as long as they are driven in a synchronized manner. Accordingly, in order to prevent these ribbon trails from being left, the control unit 15 of the printer 1 performs acceleration control when the motor 12 is accelerated from a rest state to a target speed at the start of printing with the ink ribbon 2 and the paper 3 being pressed against the thermal head 42. Hereinafter, a description will be given of the acceleration control of the motor 12 performed by the control unit 15.

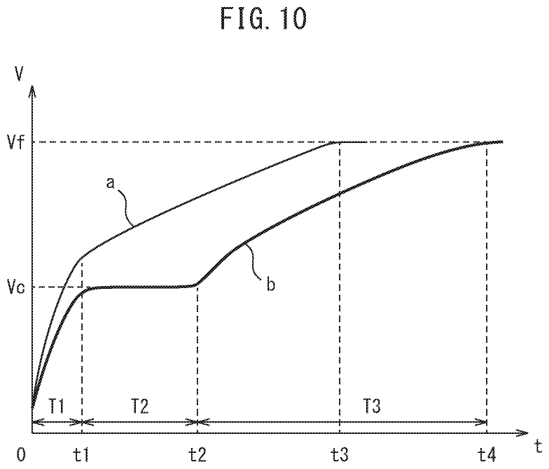

FIG. 10 is a graph for explaining the acceleration control of the motor 12 of the printer 1. The abscissa and ordinate of the graph represent time t and rotation speed V of the motor 12, respectively. FIG. 10 shows a curve a corresponding to acceleration control (second acceleration control) of a comparative example in which the ribbon trails are not taken into consideration, and a curve b corresponding to the acceleration control of the printer 1 for preventing the ribbon trails from being left, in a superposed manner. Hereinafter, the acceleration control of the curve a in FIG. 10 (second acceleration control) will be referred to as “acceleration control a,” and that of the curve b in FIG. 10 as “acceleration control b.”

In the acceleration control a, the motor rapidly accelerates from time 0, at which it is in the rest state, to time t1 at a great rate, accelerates after time t1 at a rate smaller than before, and reaches a target speed Vf at time t3. In other words, in the control of the comparative example, the motor continuously accelerates so that the rotation speed of the motor reaches the target speed Vf in minimal time. The acceleration herein corresponds to increasing the frequency of drive pulses applied to the stepper motor (gradually shortening the intervals of output of the drive pulses).

In the acceleration control b, the control unit 15 rapidly accelerates the motor 12 at a great rate in a first period T1 from time 0 to time t1, drives it at a constant speed Vc in a second period T2 from time t1 to time t2, and slowly accelerates it at a rate smaller than that of the first period T1 in a third period T3 from time t2 to time t4, so that the motor reaches the target speed Vf at time t4, which is later than time t3 in the control of the comparative example. In other words, in the acceleration control a, the motor 12 accelerates the motor from the rest state to the target speed Vf in a shorter time than in the acceleration control b.

The first period T1 is an extremely short period corresponding to a mechanical delay time up to when the driving force of the motor 12 in the rest state is transmitted to the platen roller 16 and thereby the paper 3 actually starts moving. The amount of transport of the paper 3 in the first period T1 is 1 mm or less, and the first period T1 is so short that even if the ink ribbon 2 and the paper 3 are slightly rubbed together in this period, this rubbing cannot be recognized as a stain. Since in the first period T1, the paper 3 has not substantially started moving and no ribbon trail is left, the control unit 15 accelerates the motor 12 at a rate greater than that of the third period T3 in a stroke during the first period T1, thereby reducing the time required for startup.

The second period T2 is a period in which the paper 3 substantially starts moving, and it follows the first period T1 and ends before the rotation speed of the motor 12 reaches the target speed Vf. The second period T2 is longer than the first period T1 and shorter than the third period T3. During the second period T2, the control unit 15 keeps the frequency of drive pulses of the motor 12 constant and thereby drives the motor 12 at the constant speed Vc.

Driving at the constant speed Vc in the second period T2 is control which is not performed in the acceleration control a. In the acceleration control a, the motor 12 accelerates at a rate greater than that of the second period T2 of the acceleration control b in the period from time t1 to time t2, which corresponds to the second period T2.

At time t1 when the second period T2 starts or immediately thereafter, the transport speed of the paper 3 reaches a constant speed corresponding to the rotation speed of the motor 12, and the transport speed of the ink ribbon 2 catches up with that of the paper 3 and becomes constant by time t2 when the second period T2 ends. In the second period T2, if the rotation speed of the motor 12 is too fast, the ink ribbon 2 cannot keep up with the paper 3, and a considerable difference between their speeds before the ink ribbon 2 reaches the same speed as the paper 3 may cause the ribbon trails to be left; thus, the motor 12 is driven at a moderate constant speed until the ink ribbon 2 reaches the same speed as the paper 3. Accordingly, it is preferred that the second period T2 be long enough for the speed of the ink ribbon 2 to catch up with that of the paper 3. If the speed of the ink ribbon 2 catches up with that of the paper 3 in the second period T2 and if the difference between their speeds falls within the range where the quality of printing is not affected, the control unit 15 may slightly accelerate the motor 12 in the second period T2 at a rate smaller than that of the first period T1 and the third period T3.

The third period T3 is a period which follows the second period T2 and ends when the rotation speed of the motor 12 reaches the target speed Vf. During the third period T3, the control unit 15 accelerates the motor 12 at a rate smaller than that of the first period T1 and greater than that of the second period T2, in which the acceleration is zero, i.e., at a rate greater than zero. In other words, after the speed of the ink ribbon 2 becomes substantially the same as that of the paper 3 in the second period T2, the control unit 15 quickens the rotation of the motor 12 and thereby accelerates the ink ribbon 2 and the paper 3 together to the speed corresponding to the target speed Vf. The reason for performing control such that the rate of acceleration of the third period T3 is smaller than that of the first period T1 is as follow: in the first period T1, since the ink ribbon 2 and the paper 3 are substantially stopped, the quality of printing is not affected even if they accelerate at a great rate; in contrast, in the third period T3, since the ink ribbon 2 and the paper 3 are transported, such transport as to decrease the quality of printing is not allowed.

The acceleration of a stepper motor can be expressed as the rate of change in the frequency of the drive pulse of each driving step (the interval of output of the drive pulse from the immediately preceding step to the next step). The magnitude relationship between the rates of acceleration of the first, second and third periods T1, T2 and T3 is the one between the average rates of acceleration of the respective periods. It is only necessary that the average rates of acceleration of the respective periods increase in the order of the second, third and first periods T2, T3 and T1, and there may be instantaneous values in these periods which do not satisfy this relationship as far as the quality of printing is not affected. As long as the average rates of acceleration satisfy the above relationship, the rotation speed of the motor 12 may be constant during a period in the first period T1 or the third period T3 and may temporarily reduce in a period between time 0 to time t4.

In the printer 1, the above acceleration control b causes the ink ribbon 2 to be transported more gently in the second period T2, in which the difference between the speeds of the ink ribbon 2 and the paper 3 is minimized, than in the preceding first period T1 and the succeeding third period T3 (i.e., transported so that the difference between their speeds may not fall within the range where the quality of printing is affected); thus, it is possible to prevent trails of the ink ribbon 2 from being left on the paper 3. Further, since the motor 12 rapidly accelerates in the first period T1, in which no ribbon trail is left, and also accelerates in the third period T3, i.e., after the speed of the ink ribbon 2 becomes substantially the same as that of the paper 3, the rotation speed reaches the target speed Vf earlier than in the case in which the motor continuously slowly accelerates, and it is possible to prevent the print start from delaying. In other words, the ink ribbon 2 and the paper 3 can start moving at a practical speed.

The printer 1 may operate in one of operating modes whose print speeds differ, such as a high-speed (speed-priority) mode and a low-speed (quality-priority) mode. Since the printer 1 prints while transporting the ink ribbon 2 and the paper 3, a higher print speed leads to a higher transport speed and thus to a higher target speed Vf of the motor 12. In the low-speed mode, the transport speed is slow and it is supposed that the ribbon trails are unlikely to be left; thus, if it is possible to switch between the high-speed mode and the low-speed mode, the control unit 15 may perform the acceleration control b in the high-speed mode and the acceleration control a in the low-speed mode instead of the acceleration control b. If the print speed can be switched between three or more levels, the control unit 15 may perform the acceleration control b only in some of the operating modes in which the print speed is high.

In general, not only a single type of ink ribbons 2 and paper 3 but also multiple types of ink ribbons 2 and paper 3 are usable in the printer 1. Some ink ribbons 2 are likely to cause the ribbon trails and others are unlikely to cause them, which depends on the difference between the coefficients of friction of the ink ribbon 2 to be used and the thermal head 42, and the difference between those of the ink ribbon 2 and the paper 3. For this reason, the memory 15a in the control unit 15 may store identification information on pairs of the ink ribbon 2 and the paper 3 to be used in the printer 1 and information as to which is performed, the acceleration control a or b, when each pair is used. In this case, a user may select the acceleration control a or b through the input unit 17 including an operation button provided on the body 10 or an input terminal to be connected to an external device, such as a host computer. Alternatively, the control unit 15 may refer to information stored in the memory 15a and automatically switch between the acceleration control a and the acceleration control b in accordance with the pair of the ink ribbon 2 and the paper 3 to be used.

In the case in which the ink ribbon 2 and the paper 3 are transported by the separate motors 12a and 12b as in FIG. 9(B), it is recommended that the control in the first to third periods T1-T3 may be performed with the two motors 12a and 12b being synchronized.

Some thermal printers can switch between a thermal transfer mode in which the printer is equipped with an ink ribbon and prints on general-purpose paper, and in a thermosensitive mode in which the ink ribbon is removed and the printer prints on thermal paper. In such a printer, the thermal head thermally transfers ink to print in the thermal transfer mode, and heats paper to print in the thermosensitive mode. The thermal transfer mode and the thermosensitive mode are switched by a user operation via either a button provided on the printer body or software (utility) for a printer driver installed on a host computer connected to the printer. For the thermal transfer mode, the acceleration control b is suitable, but, for the thermosensitive mode, the acceleration control a is suitable in order that the motor may reach the target speed Vf and print in a short time, because the ink ribbon is removed and the ribbon trails are not left on the thermal paper.

Accordingly, the memory 15a in the control unit 15 (an example of the memory) may store thermal-transfer control data for the acceleration control b and thermosensitive control data for the acceleration control a.

In this case, the control unit 15 may refer to a motor control table stored in the memory 15a and perform the acceleration control a or b, in accordance with that instruction to switch between the thermal transfer mode and the thermosensitive mode which is inputted to the input unit 17 (an operation button or an external input terminal) by a user operation. In other words, if it is determined that the ink ribbon 2 is attached (the thermal transfer mode) on the basis of a command received from the host computer or an operation performed on the button of the printer body, the control unit 15 performs the acceleration control b to slow the startup speed of the motor 12. In contrast, if it is determined that the ink ribbon 2 is not attached (the thermosensitive mode) on the basis of a command received from the host computer or an operation performed on the button of the printer body, the control unit 15 performs the acceleration control a to hasten the startup speed of the motor 12.

In this way, in the thermal transfer mode, the ribbon trails are prevented from being left on the paper, while in the thermosensitive mode, the rotation speed of the motor reaches the target speed in a short time; accordingly, the motor can be appropriately controlled in accordance with the presence or absence of the ink ribbon.

Although in the present embodiment, a stepper motor is illustrated as an example of the motor used for transporting the ink ribbon 2 and the paper 3, the above acceleration control can be applied to a case in which a motor other than the stepper motor is used.

1. A thermal printer comprising:
a first transporting unit transporting an ink ribbon;
a second transporting unit transporting a recording medium;
at least one motor driving the first transporting unit and the second transporting unit simultaneously;
a thermal head thermally transferring ink of the ink ribbon onto the recording medium to print; and
a controller accelerating the motor from a rest state to a target speed while the recording medium and the ink ribbon are pressed against the thermal head,
wherein as acceleration control, the controller
accelerates the motor in the rest state in a first period which is a mechanical delay time required for driving force of the motor to be transmitted to the second transporting unit,
drives the motor at a constant speed or accelerates the motor at a rate smaller than that of the first period in a second period from when the first period is ended and before the target speed is reached, and
accelerates the motor at a rate greater than that of the second period in a third period from when the second period is ended until the target speed is reached.

2. The thermal printer according to claim 1, wherein in the first period, the controller accelerates the motor at a rate greater than that of the third period.

3. The thermal printer according to claim 1, wherein the at least one motor is a single motor.

4. The thermal printer according to claim 1, wherein
the thermal printer is capable of printing in a high-speed mode or a low-speed mode, the target speed and a print speed being smaller in the low-speed mode than in the high-speed mode, and
the controller performs the acceleration control in the high-speed mode and does not perform the acceleration control in the low-speed mode.

5. The thermal printer according to claim 1, wherein
the thermal printer is capable of printing in a thermal transfer mode in which the ink ribbon is used or in a thermosensitive mode in which a thermal recording medium is used as the recording medium without the ink ribbon,
the thermal printer further comprises a memory storing thermal-transfer control data for the acceleration control and thermosensitive control data for second acceleration control in which the motor is accelerated from the rest state to the target speed in a shorter time than in the acceleration control,
the thermal head heats the recording medium to print in the thermosensitive mode, and
the controller performs the acceleration control or the second acceleration control.

6. The thermal printer according to claim 5, wherein in the second acceleration control, the controller accelerates the motor at a rate greater than that of the second period of the acceleration control in at least a period corresponding to the second period.

7. The thermal printer according to claim 5, further comprising an input unit through which a user is able to select which is to be performed, the acceleration control or the second acceleration control, wherein
the controller performs the acceleration control or the second acceleration control to accelerate the motor in accordance with an input to the input unit.
